(19) United States
(12) Patent Application Publication
(10) Pub. No.: US 2023/0242381 A1
(43) Pub. Date: Aug. 3, 2023

(54) AUTOMATIC CONTROL METHOD FOR AUTONOMOUS SAFETY ORIENTATION OF THE BOOM AT RISK OF INTERFERENCE

(71) Applicant: MANITOWOC CRANE GROUP FRANCE, DARDILLY (FR)

(72) Inventor: François LEMIRE, SOUCIEU EN JARREST (FR)

(21) Appl. No.: 18/163,039

(22) Filed: Feb. 1, 2023

(30) Foreign Application Priority Data
Feb. 1, 2022 (FR) 2200880

(51) Int. Cl. B66C 13/48; B66C 23/88

(52) U.S. Cl. CPC B66C 13/48; B66C 23/88

(57) ABSTRACT

A method for automatic control of a crane having a boom operating in a working circular area and at least one collision avoidance system detecting a risk of collision on a right side and a left side of the boom. The automatic control method, during a boom automatic and autonomous orientation step, serves to orient the boom according to an orientation direction, which is opposite to the side of the boom for which the risk of collision is detected, from a starting angular position, where the risk of collision with an obstacle has been detected, up to a first angular position for which the risk of collision is no longer detected, without the crane having need to communicate with an external system.

### FIELD

The invention generally relates to the technical field of cranes, and in particular tower cranes. The invention also relates to a control system executing this control method, and to a crane equipped with such a control system.

The invention relates more particularly to a crane control method, for which the boom of the crane is controllable in an automated control state with the aim of avoiding colliding with neighboring obstacles, in particular, with booms of neighboring cranes.

Thus, in a non-limiting example, the invention may be useful at construction sites where at least two cranes are installed and used, the booms of which operate in intersecting working circular areas.

### BACKGROUND

As is known, it may be necessary to install and use several cranes on a site to cover, because of its relief, the entire construction area, and/or to achieve the objectives targeted by the application context. However, depending on the locations where the cranes are mounted and the tasks assigned to them, it is possible that their fields of action, which describe a circular area, partially overlap. The problem raised by these overlap zones, called the interference zones, is that there is a higher or lower risk that the cranes sharing an interference zone may, during their orientation movement, be interfering in this so-called interference zone, and in the worst case colliding.

In the case that the presence of interference zone is unavoidable, some jurisdictions may require the managers of the site to equip the cranes with safety devices preventing these risks of interference and collision, such as: collision avoidance systems continuously monitoring and detecting whether, in its orientation movement, the boom of the crane will or will not encounter an obstacle (like the boom of another crane); or working space/travel limiters, for example orientation limiters. Generally, these equipments are connected and communicate with the control/command system of the crane, which controls its orientation movements.

On such sites, when all the crane operators have left their control stations, it is conventional to place all the cranes in a weather vane or out of service state, in which for each the orientation brake is released and the boom is free to turn under the action of the wind, thus aligning itself naturally in the wind.

On the other hand, in the particular case where one of the cranes is at working state with a crane operator operating, and where the crane operator of a neighboring crane is not at the control station, it is then necessary, and known, to place this neighboring crane in a state of automated control of the orientation of its boom, so that the latter does not interfere with the boom of the crane at working state.

Numerous automated control methods which are executed by the control/command system with a view to automatically orienting the boom so as to limit, or even eliminate, any risk of interference, and therefore possibly of collision, in at least one interference zone, are available in the literature, such as those cited below.

The document FR2537119 discloses an automatic control method applied to two cranes whose booms fly over each other in an interference zone, with the boom of the first of the two cranes equipped with a microwave emitter and the boom of the second of the two cranes equipped with a microwave receiver. A risk of collision between the booms of the two cranes is detected when the receiver of the second crane receives a signal from the transmitter of the first crane. In the event that a risk of collision is detected, the automatic control method is predicted to block maneuver commands implementing one or more movements of the first and/or of the second crane.

The documents EP3495310, EP3495311 and FR3030496 disclose automatic control methods for which, if the collision avoidance system of a first crane which is located in an interference zone detects a risk of collision with a second crane, said first crane performs an orientation in order to firstly get out of the interference zone, and secondly to position itself in a configuration such that the boom is aligned with the wind or in a direction substantially parallel to the wind, the orientation being done according to an orientation direction such that the first crane crosses as few interference zones as possible.

The document US2020/0399098 relates to an automatic control method designed such that, in the case of a risk of interference between a first crane in operation and a second crane which is not in operation, the first crane stops then communicates with the second crane so that the latter becomes operational and performs an orientation, in the orientation direction opposite to the movement of the first crane, until there is no longer any risk of interference between the two cranes. Once the second crane is in a safety configuration, the first crane restarts and again continues its orientation in order to carry out the task assigned to it.

Similarly, the document FR2876992 proposes an automatic method for bringing a set of interfering cranes into weather vane position, for which each of the cranes comprises an automaton in which the data concerning the current state of the associated crane are analyzed, and which are transmitted to the automatons of the other cranes, and characterized in that a weather vane signal is emitted by each crane and that the automaton of the crane only authorizes effectively bringing the crane into a weather vane position when the signal sent by the automatons of each of the other cranes indicates to it that a working boom is not sweeping the area swept by the boom of the crane out of service to which it belongs.

Independently of their performance and their efficiency, the disadvantage of these automatic methods is that they all require for their implementation to make the interfering cranes communicate with each other with the design of hardware and/or software and/or protocol solutions allowing the exchange between cranes, in real time, of information necessary for interference calculation (as in the case of EP3495310, EP3495311 and FR3030496), of motion and stop orders (US2020/0399098); or even to establish priority rules which determine, among other things, when a risk of interference is detected between two cranes, the conditions for which one crane takes precedence over the second depending, for example depending on their state (working, idle, automatic, etc. state) or on the task assigned to them. The priority rules are therefore established according to the application and environment contexts of the site, inducing to know/control all the situations that may occur.

Thus, the application of these methods may be costly in terms of resources and difficult depending on the degree of complexity of the application context: relief of the terrain of the site with or without unevenness, number of interfering cranes installed on the site and extent of the interference zones, tasks assigned to the interfering cranes, etc.

### SUMMARY

The object of the invention is to propose an automatic control method for securing interfering cranes which is efficient but also easy to implement and use, providing automatic orientation of the boom of a crane being in an automated control state and positioning it in a completely autonomous safety configuration, that is to say without the need to communicate with any system external to the crane.

Thus, the invention proposes a method for automatically controlling a crane in an automated control state, said crane comprising a boom and at least one collision avoidance system adapted to detect a risk of collision on a right side and a left side of the boom, said boom being controllable in orientation about an orientation axis and operating in a working circular area, said automatic control method configured to implement, when the at least one collision avoidance system detects a risk of collision with an obstacle located on the right side or the left side of the boom when the latter is in a starting angular position, an automatic and autonomous orientation step during which the boom is oriented from this starting angular position in an orientation direction, which is opposite to the right or left side for which the risk of collision is detected, at least until the at least one collision avoidance system no longer detects the risk of collision.

The automatic control method is thus defined as being centered on the crane and on the detections of risk of collision which may possibly arrive from the right side and/or from the left side of its boom, in its working circular area. Any element entering the working circular area of the crane and for which a risk of collision with the boom is detected is only perceived as an obstacle. Advantageously, this means that it is not necessary to know the number of interfering elements nor their nature, which can be a load as well as the boom of another crane. This also implies that if the obstacle is a second crane, its (working, weather vane, etc.) state does not need to be known.

When a risk of collision is detected by the collision avoidance system between the boom of the crane and an obstacle, the automatic control method, during the so-called automatic and autonomous orientation step, will carry out automatically and in perfect autonomy (therefore without receive external instructions) an orientation of the boom of the crane in an orientation direction opposite to that of the side of the boom where the risk of collision was detected, from the starting angular position in which the boom was located at the moment of the detection of the risk of collision until at least reaching an angular position for which the risk of collision is no longer detected.

Advantageously, a particular non-limiting embodiment of the automatic control method may only require, for the detection of a risk of collision and the implementation of the automatic and autonomous orientation step, minimally at least one collision avoidance system equipping the crane and capable of detecting the risks of collision coming from the left side and the right side of its boom (of course, and as specified later, the implementation of the method may require its implementation and its execution by the control/command system of the crane, which is also in communication with the at least one collision avoidance system). No communication with a system external to the crane and its equipment is necessary or planned, hence the autonomy of the automatic control method.

According to one characteristic of the invention, during the automatic and autonomous orientation step, the boom is oriented in the orientation direction until reaching or exceeding a first angular position corresponding to an angular position, starting from the starting angular position, from which the at least one collision avoidance system no longer detects a risk of collision.

According to one characteristic of the invention, during the automatic and autonomous orientation step, the boom is oriented in the orientation direction until reaching or exceeding a precautionary angular position located at a precautionary angular distance from the first angular position.

During the automatic and autonomous orientation step, the automatic control method orients first of all the boom of the crane in the orientation direction opposite to the side where the collision risk detection occurred until reaching an angular position, called the first angular position, for which the risk of collision is no longer detected. However, in order to leave an additional safety margin to further minimize the risk of collision between the crane and the detected obstacle, or even to take into account for example the degree of precision/the margin of error of the at least one collision avoidance system, the orientation is continued in the same orientation direction over a certain, called precautionary, angular distance from the first angular position, until at least reaching an angular position called the precautionary angular position.

According to one embodiment of the invention, the precautionary angular distance is non-zero and configurable, and is for example between 3 and 10 degrees.

In other words, such a configurable precautionary angular distance may be considered in the definition of the control method. It can for example be between 3 and 10 degrees, and for example of the order of 5 degrees. According to alternative embodiments, this value may be: either fixed by the designers of the automatic control method; either chosen from the value range indicated by an operator who is going to execute it, for example during a preliminary setting step.

According to one characteristic of the invention, the automatic control method comprises a selection sub-step included in the automatic and autonomous orientation step, a final angular position is selected for which an interference parameter representative of a level of risk of interference between the boom and an obstacle is low, and the boom is oriented in the orientation direction until reaching and stopping in said final angular position.

Thus, the purpose of the automatic and autonomous orientation step is to orient the boom of the crane from its starting angular position, where the risk of collision with an obstacle has been detected, until it is stopped and positioned in an safety angular position, called the final angular position, for which there is no longer any risk of collision with the obstacle but also for which the risk of interference/collision with one or more other obstacles is not high. This final angular position is chosen during the selection sub-step taking place during the automatic and autonomous orientation step, on the basis of the interference parameter which is representative of a level of risk of interference.

According to one characteristic of the invention, the automatic control method uses an interference mapping representative of the working circular area and in which each angular position is associated with a value of the interference parameter, and during the selection sub-step, the final angular position is selected from the angular positions of the interference mapping according to their values of interference parameter.

As indicated above, the automatic control method selects, during the selection sub-step, a final angular position on the basis of an interference parameter which is representative of a level of risk of interference/collision between the boom of the crane and an obstacle. For this, it relies on an interference mapping for which each angular position of the working circular area is associated with a value of this interference parameter such that the smaller this value, the lower the level of risk of interference between the boom and an obstacle; the larger this value, the higher the level of risk of interference.

According to one embodiment of the invention, in the interference mapping, the values of interference parameter associated with each of the angular positions of the interference mapping are either fixed or can evolve over time.

As indicated, two types of mapping may be proposed. In a first case, the values of the interference parameter for each angular position are fixed. It can be assumed that the environment of the crane is under control of the operators, with precise knowledge of the interference zone(s) present and the level of risk of interference that may be associated with them.

In a second case, the values of the interference parameter of each of the angular positions can evolve over time and during the various actions possibly executed by the crane. Thus, the automatic control method may, as the risk of collision between the boom and one or more obstacles is detected, when the said boom is positioned in an angular position or when it orients it, discover and memorize in real time new interference zones, reassess the level of risk of interference of already known interference zones (actual risk of interference higher than the risk of interference estimated by the operator), to then adapt to it and optimize future orientation movements of the crane which will reduce or even eliminate the risk of interference.

According to one characteristic of the invention, the interference mapping is constructed by implementing the following steps:
an initial segmentation step during which the working circular area is segmented into several angular sectors, each of the angular sectors being able to comprise one or more angular positions;
an initial setting step during which each of the several angular sectors is associated with an interference counter representative of a level of risk of interference in the associated angular sector between the boom and a possible obstacle, said interference counter constituting thus the interference parameter, and the value of the interference parameter of one or more angular positions included in an angular sector taking the value of the interference counter associated with said angular sector;
when the values of interference parameter have been planned to evolve over time, a construction step during which, the crane being either in a working state or in an automated control state, whether the boom is in motion or not, and each time the boom is present in an angular position of an angular sector among the several angular sectors, and that the at least one collision avoidance system detects a risk of collision in said angular sector, then the value of the interference counter in said angular sector, and consequently the value of the interference parameter of the one or more angular positions included within it, is incremented.

The construction of the mapping is based first of all on an initial segmentation step during which the working circular area is segmented into several angular sectors which may each contain, according to different modes of definition and embodiments of the mapping, one and/or more angular positions. Each of the angular sectors is then defined, during an initial setting step, by an interference counter representative of a level of risk of interference between the boom and an obstacle in this angular sector. This angular counter therefore corresponds to the interference parameter mentioned above. Thus, the value of the interference parameter of the one or more angular positions contained in an angular sector take the value of the interference counter of said angular sector.

The two initial steps described are sufficient to constitute a mapping for which the values of the interference parameter are fixed.

In the case where the values of the interference parameter of each of the angular positions evolve in real time and during the various actions possibly executed by the crane, a third step called the construction step is implemented: whatever the state of the crane, when the boom is positioned in an angular position of an angular sector and the at least one collision avoidance system detects a risk of collision in this angular sector, then the value of the interference counter, and consequently the value of the interference parameter of the one or more angular positions included within it. More precisely, this means that, when the boom is oriented following a detection of collision, the values of the interference counters of the angular sectors it crosses, from the starting angular sector where it was positioned up to the angular sector containing the first angular position excluded, are incremented.

According to one characteristic of the invention, during the selection sub-step, the angular sector containing the final angular position, called the final angular sector, is selected from angular sectors, called the nearby angular sectors, which include: the angular sector containing the precautionary angular position, called the precautionary angular sector, and angular sectors which are distributed over a given limit angular distance from said precautionary angular sector.

According to one characteristic of the invention, the limit angular distance is less than or equal to 360 degrees, and for example less than or equal to 180 degrees.

In other words, the final angular position is considered to be contained in an angular sector called the final angular sector. The automatic control method, during the selection sub-step, will choose a final angular sector in which to complete the orientation movement of the crane among several angular sectors, called the nearby angular sectors, included in a given limit angular distance from and including the precautionary angular sector.

The value of the limit angular distance is less than or equal to 360 degrees, thus authorizing at most one complete or almost complete turn. Alternatively, the value of the limit angular distance is less than or equal to 180 degrees, thus authorizing a maximum of a half-turn.

In an alternative embodiment of the automatic control method, this value of the limit angular distance which may be predefined is fixed. In another alternative embodiment, this value may be given by the operator within the value range specified during, for example, a preliminary setting step of the automatic method (which may correspond to the initial setting step of the mapping).

According to one characteristic of the invention, during the selection sub-step, the values of the interference counters of the nearby angular sectors are compared with a minimum value and the nearby angular sector(s) having a value of interference counter lower than or equal to said minimum value is or are called the secured nearby angular sectors, and the final angular sector is selected from said secured nearby angular sector(s).

In other words, in connection with the previous point, the limit angular distance comprises several angular sectors, called the nearby angular sectors, which are all potential final angular sectors in which the automatic control method may stop the orientation movement and position the boom. During the selection sub-step, the automatic control method carries out a first sorting of the potential candidates by comparing the value of their interference counter with a minimum value of interference counter, which establishes a low threshold for which is estimated that the risk of interference is insignificant. The nearby angular sectors whose value of interference counter is less than or equal to this minimum value are selected as promising candidates, these nearby angular sectors then being called the secured nearby angular sectors.

According to one characteristic of the invention, during the selection sub-step, the minimum value corresponds to the lowest value of the interference counters of the nearby angular sectors, or to the lowest value of the interference counters of the nearby angular sectors incremented by a configurable increment value.

The minimum value serving as the first selection criterion may correspond either to the lowest value of the interference counters of the nearby angular sectors; or the lowest value of the interference counters of the nearby angular sectors incremented by a configurable increment value, this increment value possibly corresponding for example to one or two increment units.

In the first case, only the nearby angular sectors having the lowest value of interference counter, that is to say for which the risk of interference is the lowest, are considered as secured nearby angular sectors.

However, and depending on the application context, this value may be relatively restrictive. For example, the nearby angular sector(s) having the lowest value of interference counter may potentially be relatively far from the precautionary angular sector, while nearby angular sectors which are much closer to the precautionary angular sector may have a value of interference counter certainly higher than the lowest value of interference counter, but for which the risk of interference remains low. However, it is possible that these sectors are more interesting for the positioning of the boom, because they are near the sectors where the detection took place; it can be assumed that the crane was working in its starting angular sector, and that it needs to return to this sector.

The purpose of the second case is to address this drawback by offering a better compromise between positioning the boom in a secured sector following a detection of risk of collision and controlling the application context (in the example given above, avoid unnecessary loss of time by allowing the crane to be able to return as quickly as possible to the angular sector in which it was working).

According to one characteristic of the invention, during the selection sub-step, the final angular sector is selected as being a secured nearby angular sector, from the secured nearby angular sectors, and which is:
either the one which is angularly nearest the precautionary angular sector;
either the one which, on the one hand, has a value of the interference counter which is equivalent to the lowest value of the interference counters of the nearby angular sectors and, on the other hand, is the angularly nearest the precautionary angular sector.

In connection with the previous point, following the application of the first selection criterion having made it possible to identify secured nearby angular sectors on the limit angular distance, the second and last criterion applied in order to determine the final angular sector is to choose the secured nearby angular sector which:
in the first case, has the lowest value of interference counter and is the angularly nearest the precautionary angular sector;
in the second case, which has a value of interference counter which is lower than the defined minimum value (without however corresponding to the smallest value of interference counter), and which is angularly near the precautionary angular sector.

In both cases, it is possible, depending on the values of interference counters, that the chosen final angular sector is the precautionary angular sector. At this moment, this means that the step of automatic and autonomous orientation of the boom ends when the automatic control method orients the boom in the precautionary angular sector. If not, the automatic control method must orient the boom again over a certain angular distance separating the precautionary angular sector from the determined final angular sector.

According to one characteristic of the invention, during the selection sub-step, the values of the interference counters of the nearby angular sectors are compared with a maximum value and the nearby angular sector(s) having a value of interference counter greater than or equal to said maximum value is or are called the risky nearby angular sectors,

and in which the final angular sector is selected from the nearby angular sectors extending in a delimited secured angular interval, on the one hand, by the included precautionary angular sector and, on the other hand, by the risky nearby angular sector or by the first sector of the risky nearby angular sectors starting from the precautionary angular sector excluded;
so that, during the step of automatic orientation of the boom, the boom does not reach and does not exceed said risky nearby angular sector or said first sector of the risky nearby angular sectors starting from the precautionary angular sector.

According to one characteristic of the invention, during the selection sub-step, the final angular sector is selected as the nearby angular sector having the lowest value of the interference counter in the secured angular interval, independently of the values of the interference counters of the nearby angular sectors located beyond said secured angular interval.

When applying the first selection criterion, the values of the interference counters of the nearby angular sectors included in the limit angular distance are also compared with a maximum value corresponding to a threshold value for which the risk of interference between the boom and an obstacle is very high.

Any angular sector having a value of interference counter greater than this value is considered a risky nearby angular sector. Depending on the application context, the limit angular distance may include one or more risky nearby angular sectors (successive or not). The objective is for the automatic control method to stop the orientation of the boom before reaching the first sector of the one or more risky nearby angular sectors.

If at least one risky nearby angular sector is identified, then the automatic control method will modify its selection criterion, by choosing as final angular sector the nearby angular sector having the smallest value of interference counter among the nearby angular sector(s) included in a secured angular interval delimited by the precautionary angular sector and the first sector of the risky nearby angular sectors that may be encountered in the direction of the orientation movement (this risky nearby angular sector being excluded from the secured angular interval). As indicated previously, according to the values of interference counter of the angular sectors included in the secured angular interval, the final angular sector may correspond to the precautionary angular sector.

According to one characteristic of the invention, during the selection sub-step, the final angular position corresponds, in the final angular sector, to the angular position that is spatially nearest the included precautionary angular position.

In other words, once the final angular sector has been selected/identified, the automatic control method will choose as final angular position where to position the crane the angular position contained in the final angular sector which is spatially nearest the precautionary angular position, that is to say such that the angular distance between the precautionary angular position and this final angular position is the shortest.

According to one characteristic of the invention, during the initial segmentation step, the working circular area is segmented into at least 36 angular sectors.

According to one embodiment of the invention, during the initial segmentation step, the working circular area is segmented into at least 120 isometric angular sectors.

According to one embodiment of the invention, during the initial setting step, the value of the interference counter of each of the several angular sectors is the smallest value defined in said control method.

It is at least provided for the construction of the interference mapping that, during the initial segmentation step, the working circular area is segmented at least into 36 angular sectors which may or may not be isometric, that is to say containing or not the same number of angular position.

According to different embodiments of the invention, a default interference mapping is provided to the operator, for which the working circular area is segmented into 120 isometric angular sectors, that is to say each having an angular distance of 3 degrees, or 3 angular positions. Said embodiments may propose that this segmentation is fixed, or modifiable by the operator.

Also, according to a given embodiment, the default interference mapping proposes an assignment of the values of interference counters such that, in the initial operating state of the crane (t=0), the value of interference counter of all angular sectors is the smallest possibly definable, meaning that all angular sectors are initially considered de-risked.

The invention also relates to an automatic control system for the automatic control of a crane in an automated control state, said crane comprising a boom and at least one collision avoidance system adapted to detect a risk of collision on a right side and a left side of the boom, said boom being controllable in orientation about an orientation axis and operating in a working circular area, said automatic control system communicating/exchanging information with the at least one collision avoidance system and controlling the boom, and in which said automatic control system is designed to contain and to execute, when the at least one collision avoidance system detects a risk of collision with an obstacle located on the right side or the left side of the boom when the latter is in an angular position, a program comprising a list of instructions related to an implementation of an automatic control method according to the present invention.

In other words, the automatic control method presented in the scope of the invention is implemented in then executed by an automatic control system, said automatic control system controlling the orientation movements of the crane, and being connected to the at least one collision avoidance system, with which it communicates. Thus, when the at least one collision avoidance system detects a risk of collision at the right side or the left side of the crane, it transmits this information to the automatic control system which will then apply the automatic control method, by implementing the construction steps, followed by the automatic orientation and selection steps. The automatic control system is not exhaustively an electronic card, or a processor, or a controller, or a computer, or a combination of all or part of these elements.

The invention also relates to an automatically controllable crane comprising a boom and at least one collision avoidance system adapted to detect a risk of collision on a right side and a left side of the boom, said boom being controllable in orientation about an orientation axis and operating in a working circular area, said automatically controllable crane further comprising an automatic control system according to the present invention and communicating/exchanging information with the at least one collision avoidance system and with the boom for control it in rotation in the automated control state.

### BRIEF DESCRIPTION OF THE DRAWINGS

Other characteristics and advantages of the present invention will become apparent on reading the detailed description below, of a non-limiting example of implementation, made with reference to the appended figures in which:

FIG. 1 is a schematic view of an example of crane comprising a command system adapted for the implementation and the execution of the automatic control method;

FIG. 2 is a flowchart describing the operating principle of the automatic control method in its most complete embodiment, and implemented when the crane is in an automated control state;

FIG. 3 is a flowchart describing the operation of the automatic and autonomous orientation step of the boom in its most complete embodiment;

FIG. 4 schematically illustrates a real environment context for which a first crane, equipped with the automatic control method, sees its working circular area partially overlap those of a second crane and of a third crane in two interference zones, the three cranes being initially in arbitrary angular positions (FIG. 4a); and for which said environmental context, all the orientation sub-steps included in the step of automatic and autonomous orientation of the boom following the detection of a risk of collision between the boom of the first crane and the boom of the second crane due to an orientation movement of the boom of the second crane (FIG. 4b) are implemented, with: a first orientation of the boom of the first crane, in the orientation direction opposite the side of the boom where the risk of collision has been detected, from its starting angular position to a first angular position where the risk of collision is no longer detected (FIG. 4c); a second optional orientation, in the same orientation direction, from the first angular position to the precautionary angular position (FIG. 4d); and finally a third optional orientation, always in the same orientation direction, from the precautionary angular position to reach a final angular position (FIG. 4e);

FIG. 5 schematically illustrates, when the automatic control method, according to one embodiment, relies on an interference mapping to position the boom of the first crane in a final angular position: how, during an initial segmentation step, the working circular area of the first crane is the subject of virtual modeling for which it is segmented into a plurality of angular sectors each comprising at least one angular position (the boom of the first crane is shown superimposed on this segmented working circular area); an example of illustration of interference mapping representative of the working circular area of the first crane, constructed from this virtual modeling then during the initial setting step and, optionally, during the construction step.

FIG. 6 is equivalent to the situations described in FIGS. 4a to 4c, and schematically illustrates for each of the situations (top figures) how the interference mapping representative of the working area of the first crane (bottom figures) when said interference mapping is defined/designed to evolve in real time following the detection of a risk of collision by the at least one collision system of the first crane and during the implementation of the first sub-step of orientation of the boom of the first crane is updated during the construction step;

FIG. 7 is equivalent to the situations described in FIGS. 4a to 4c, and schematically illustrates, in comparison with FIG. 6, an embodiment for which the interference mapping is not intended to evolve in real time, the interference mapping then being entered by an operator during the initial setting step.

FIG. 8 is equivalent to FIG. 6 or FIG. 7, and follows the situation described in FIG. 6c or 7c, illustrating the orientation of the boom of the first crane during the second orientation sub-step from the first angular position until reaching the precautionary angular position located in the precautionary angular sector, beyond the first angular position included in the first angular sector;

FIG. 9 is equivalent to FIG. 8, and comes after the situation described in FIG. 8, illustrating the start of the selection sub-step included in the step of automatic and autonomous orientation of the boom of the first crane, whose interference mapping is shown in the figure on the right, for which the angular sectors included in an angular distance are considered to be nearby angular sectors;

FIG. 10 schematically illustrates the first crane (on the left) of FIG. 9 and its associated interference mapping (on the right), during the step of automatic and autonomous orientation of the boom of the first crane until reaching a final angular position included in a final angular sector. The final angular sector and the final angular position are established during the selection sub-step, having a minimum value and a maximum value of the interference counter respectively equal to 1 and 5;

FIG. 11 schematically illustrates the first crane (on the left) of FIG. 9 and its associated interference mapping (on the right), during the step of automatic and autonomous orientation of the boom of the first crane until reaching a final angular position included in a final angular sector. The final angular sector and the final angular position are established during the selection sub-step, having a minimum value and a maximum value of the interference counter respectively equal to 2 and 5; and

FIG. 12 schematically illustrates the first crane (on the left) of FIG. 9 and its associated interference mapping (on the right), during the step of automatic and autonomous orientation of the boom of the first crane until reaching a final angular position included in a final angular sector. The final angular sector and the final angular position are established during the selection sub-step, having a minimum value and a maximum value of the interference counter respectively equal to 0 and 4;

### DESCRIPTION

The automatic control method DPA which is the subject of the invention is implemented by being performed in a control system 1c equipping a crane G which is in an automated control state EA, then is executed by this same control system 1c. The control system 1c comprises for example all or part of the following elements: an electronic card, a processor, a controller, a computer. It comprises for example a memory in which is loaded a program containing a list of instructions for the implementation, for example by a processor or a computer, of this automatic control method DPA.

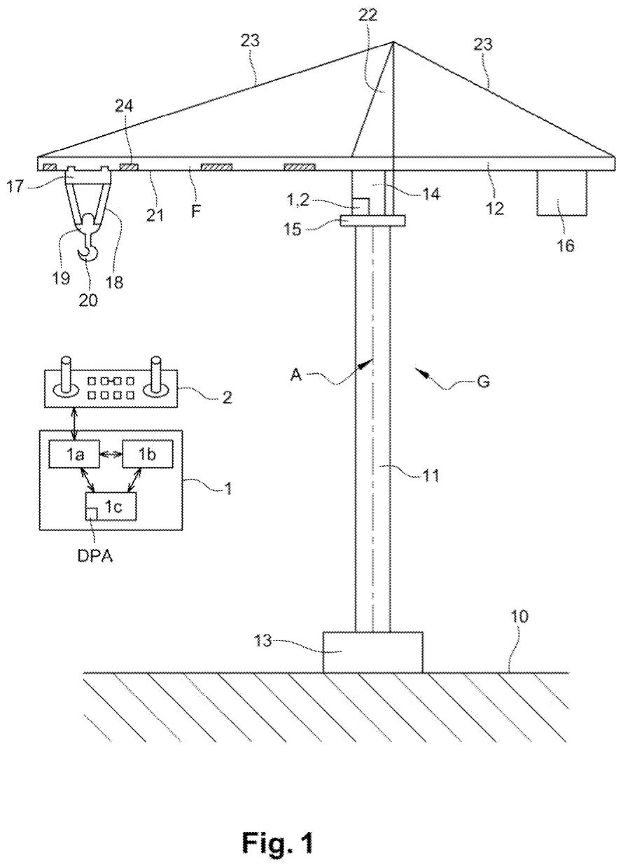

According to the proposed embodiment and with reference to FIG. 1, the control system 1c is integrated into the control/command system 1 of the crane G, which can for example be installed in a control cabin 14.

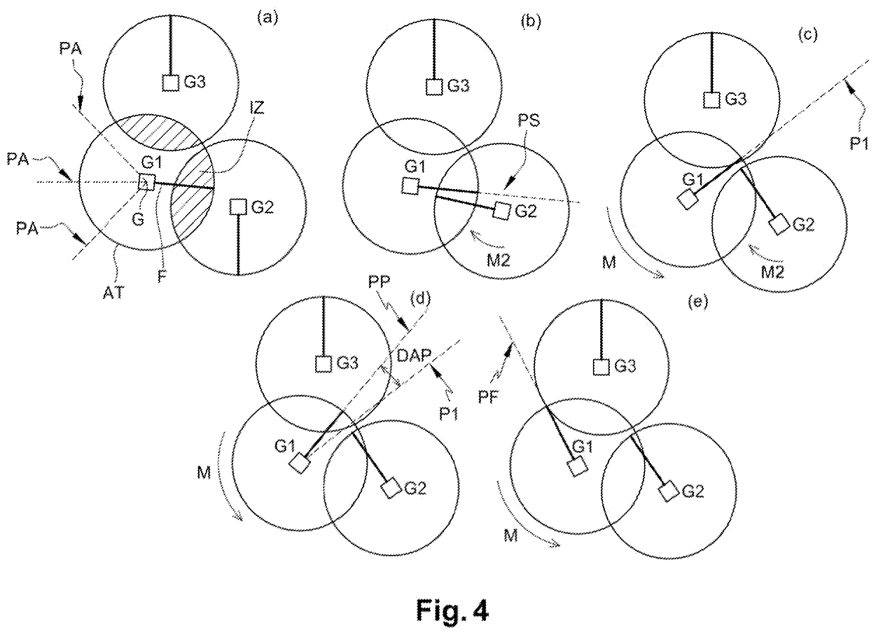

The illustrated crane G is a tower crane which comprises a mast 11 mounted on a platform 13 which can be fixed to the ground 10 or can be mobile (for example by being placed on rails); and a rotating assembly formed by a boom F and a counter-boom 12 substantially aligned, and optionally an boom holder 22 (or punch) with tie rods 23, said rotating assembly being rotated about an orientation axis A, which is of vertical extension, by means of an orientation ring 15 coupled to at least one orientation motor, causing the boom F to sweep a circular zone about the orientation axis A, this circular zone corresponding to its working circular area AT shown schematically in FIGS. 4 to 14. A counterweight 16 (or ballast block) is positioned on the counter-boom 12 to counterbalance the weight of a load lifted by the crane G as well as stabilize the latter during its orientation movements.

The load is lifted by means of a hook 20 located at the end of a reeve-block 19 which is moved vertically by means of at least one lifting cable 18 attached to a distribution trolley 17 movable in translation on a rolling path 21 provided along the boom F.

The crane G can be either in a working state in which a manual control of the orientation of the boom F is implemented by a crane operator (and more generally a control of the various maneuvers to move a load), or in the state of automated piloting EA in which an automated piloting of the orientation of the arrow F is implemented.

In this embodiment, the control/command system 1 comprises a central unit 1a in connection with the control system 1c; the central unit 1a whose role is to orchestrate/ensure the proper functioning of the crane G and in particular the implementation of the movements of the elements of the crane (orientation of the boom, optional raising/lowering of the boom) and of the load (moving the distribution trolley, lifting the reeve-block and the load).

The control/command system 1 comprises a collision avoidance system 1b which receives, from one or more sensors 24 disposed on the crane G, and for example on the boom F (such as for example millimetric wave radar sensors), information of detection of risk of collision between the boom F and an obstacle coming from its right side or its left side.

The central unit 1a also communicates with the at least one collision avoidance system 1b, and also receives command orders from a control panel 2 used by the crane operator in order to be able to maneuver the crane G.

The automatic control method DPA is applied in the scope of site environment contexts for which the boom F of a first crane G1, which is shaped to implement the automatic control method DPA and which is in an automated control state EA, may, when positioned in an angular position PA or in rotation in its working circular area AT, potentially interfere with different types of obstacle, for example: the boom(s) of other cranes G2 and/or G3, because the working circular areas AT of the first crane G1 or of said other crane(s) G2, G3 overlap interference zones IZ (this site environment context being shown in FIG. 4); buildings such as their location on the site may also occupy part of the size of the working circular area AT of the first crane G1.

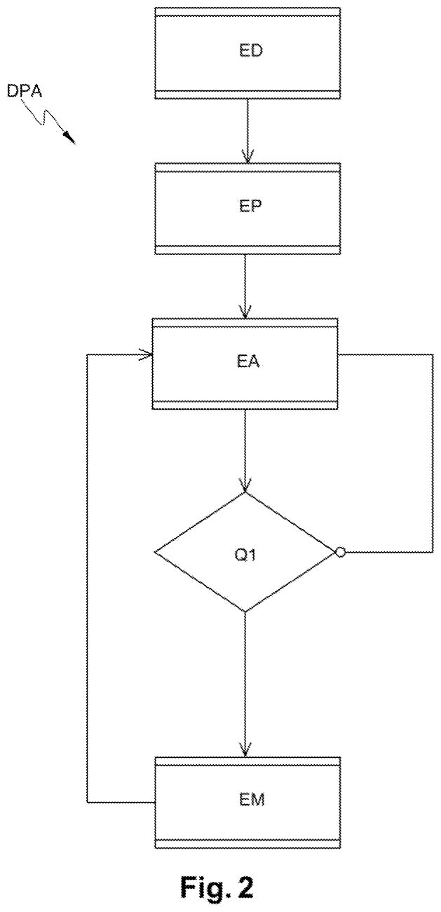

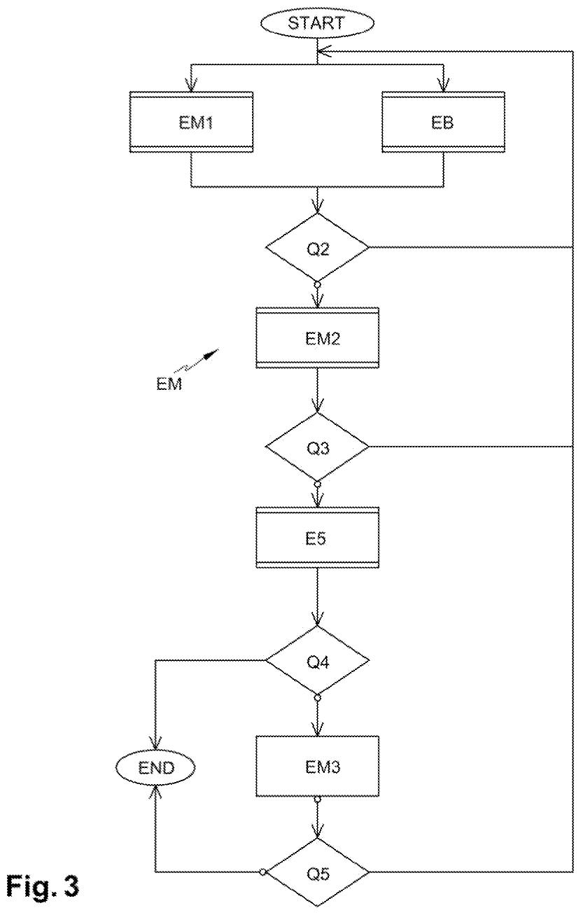

The automatic control method DPA can be implemented according to several alternative embodiments, the most complete alternative embodiment being illustrated in FIGS. 2 and 3. The operating principle of the alternative embodiments of the automatic control method DPA will be illustrated and explained in through the site environment context shown in FIG. 4, for which the boom F of the first crane G1 is positioned in an angular position PA included in the interference zone IZ that it shares with a second crane G2 which is in a working state (FIG. 4a). A third crane G3 is also considered to be in working state.

The automatic control method DPA implements, in all its possible alternative embodiments, a boom automatic and autonomous orientation step EM when it receives, coming from the at least one collision avoidance system 1b or from the central unit 1a, during a reception step Q1, information of a detection of a risk of collision. Otherwise, the automatic control method DPA remains in a waiting/standby state if it does not receive such information representative of a detection of a risk of collision. In the example shown in FIG. 4b, a risk of collision is detected between the boom F of the first crane G1 and the boom of the second crane G2 following a clockwise orientation movement M2, such as said risk of collision is detected on the right side of the boom F of the first crane G1.

In its simplest alternative embodiment, the boom automatic and autonomous orientation step EM comprises a first orientation sub-step EM1 consisting of an orientation of the boom F of the first crane G1, in the orientation direction M opposite to the side of the boom where the risk of collision was detected (that is to say clockwise orientation direction M if the risk of collision was detected on the left side of the boom F, counterclockwise orientation direction M if it was detected on the right side), from the starting angular position PS where the risk of collision was detected up to a first angular position P1 for which the risk is no longer detected (FIG. 4c) by the collision avoidance system 1b.

Optionally, the boom automatic and autonomous orientation step EM comprises, following the first orientation sub-step EM1, a second orientation sub-step EM2 during which the automatic control method DPA continues the automated orientation of the boom F of the first crane G1 in the orientation direction M from the first angular position P1 over an angular distance called the precautionary angular distance DAP. The angular position in which the boom F of the first crane G1 is positioned is then called the precautionary angular position PP located at the precautionary angular distance DAP from said first angular position P1.

This second orientation sub-step EM2 is implemented so that an additional safety margin is left to further minimize the risk of collision between the boom F of the first crane G1 and the detected obstacle (here the boom of the second crane G2), or even to take account, for example, of the degree of precision/of the margin of error of the at least one collision avoidance system 1b.

Optionally, the boom automatic and autonomous orientation step EM comprises, following the second orientation sub-step EM2 (respectively the first orientation sub-step EM1 if the second orientation sub-step EM2 is not implemented), a third orientation sub-step EM3 during which the automatic control method DPA continues the automated orientation of the boom F of the first crane G1 in the orientation direction M from the precautionary angular position (respectively from the first angular position P1) until reaching a final angular position PF for which the risk of interference IR between the boom F and an obstacle is low, or even non-existent (FIG. 4e).

The final angular position PF is determined by the automatic control method DPA during a selection sub-step ES taking place upstream of the third orientation sub-step EM3 and which will be described later.

The implementation of the selection sub-step ES and of the third orientation sub-step EM3 is based on the definition and the use of an interference mapping C representative of the working circular area AT of the first crane G1 for which each angular position PA is associated with a value of an interference parameter which corresponds to the level of risk of interference IR between the boom F of the crane G1 and an obstacle in said angular position PA.

The interference mapping C may be defined and designed according to two embodiments: either the values of the interference parameters of the angular positions PA are only entered manually by an operator before the effective implementation of the automatic control method DPA; either the values are optionally entered manually by an operator, but they evolve automatically in real time as the automatic control method DPA operates and the risks of collision detected between the boom F of the first crane and an obstacle (more details are given below).

Whatever the type of provided interference mapping C, it is necessary to implement in the automatic control method DPA two steps taking place successively at the start of the latter: an initial segmentation step ED, and a setting step EP.

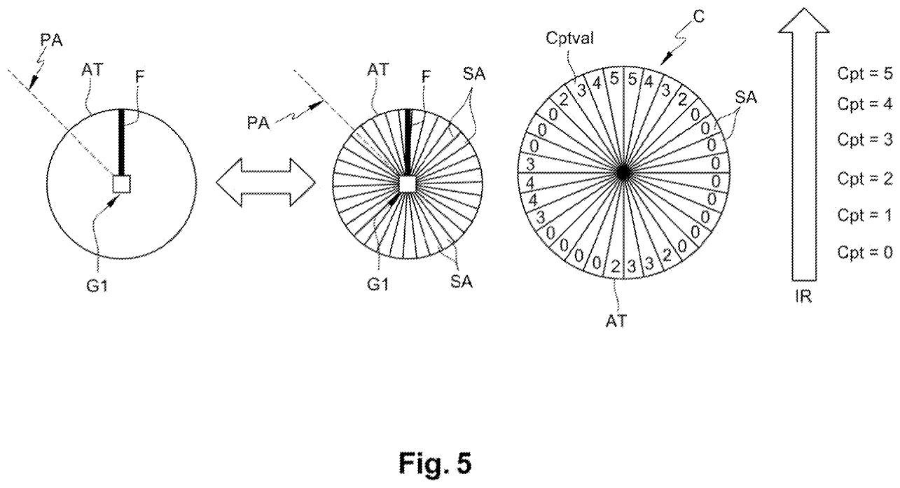

Referring to FIG. 5, the interference mapping C is constructed on the basis of a virtual model created during an initial segmentation step ED taking place following the start of the automatic control method DPA. During this initial segmentation step ED, the automatic control method DPA implements a virtual modeling of the working circular area AT of the first crane G1 such that it is segmented into a plurality of angular sectors SA. By misuse of language, for reasons of clarity, the actual working circular area and the modeled working circular area will bear the same reference “AT” in the present description.

In this modeling, the elements of the environment external to the first crane G1 are not modeled, and in particular the neighboring cranes or other cranes G2, G3, or any other potential obstacle such as a building, are not represented and considered in the modelling. Thus, the interference zones IZ are also not present in the modeling of the working circular area AT, and therefore in the resulting interference mapping C.

By definition, any angular sector SA comprises at least one angular position PA. The automatic control method DPA is defined as intended that the virtual model of the working circular area AT of the first crane G1 is at least segmented into 36 angular sectors SA. In a preferred embodiment, the working circular area AT is segmented into 120 isometric angular sectors SA (that is to say each making 3 degrees, namely comprising 3 angular positions PA).

According to different embodiments, either the number of angular sectors SA defined in the virtual model is fixed by the designers of the automatic control method DPA, or it may be parameterized by an operator through an option offered by a software accessible from the control/command system 1 (in which case the operator must validate his setting so that the control method may continue).

For reasons of clarity and understanding of the operating principle of the automatic control method DPA, the working circular area AT of the first crane G1 is segmented into 32 isometric angular sectors in FIGS. 5 to 12.

Following the initial segmentation step ED, the automatic control method DPA implements the initial setting step EP during which it constructs, from the virtual model, an interference mapping C, by associating each of the angular sectors SA, segmenting the working circular area AT, an interference counter Cpt being able to take a value Cptval representative of a level of risk of interference IR such that: the smaller the value Cptval, the greater the risk of interference IR between the boom F of the first crane G1 and an obstacle; and conversely, the larger the value Cptval of the interference counter Cpt, the greater the risk of interference IR. By correlation, the interference parameter of an angular position PA corresponds to the interference counter Cpt of the angular sector SA, and any angular position PA included in a given angular sector SA has its value of interference parameter equal to the value Cptval of the interference counter Cpt of this said angular sector SA.

The range of values that can be taken by the value Cptval may be different according to several possibilities of realization, depending on the level of risk IR that the designers associate with a value. In the presented embodiment, the interference counter Cpt may take at least six integer values of Cptval ranging from 0 to 5, such that the level of risk of interference IR is: zero when the value Cptval is equal to 0, very low when equal to 1, low when equal to 2, medium when equal to 3, high when equal to 4, and very high when equal to 5. An example of interference mapping C is illustrated in FIG. 5. It is possible in other embodiments for the range of values Cptval to be wider, or on the contrary narrower.

By default, during the initial setting step EP, the automatic control method DPA constructs the interference mapping C such that the interference counter Cpt of each of the angular sectors SA is equal to the lowest value Cptval.

The setting sub-step EP may be carried out according to two variants:
In a first variant, the setting sub-step EP may be fully automated. It is exclusively and only applicable in the case where it is provided that the interference mapping C can evolve automatically and in real time over the operation of the automatic control method DPA and the detections of risk of collision between the boom F of the first crane and an obstacle.
In a second variant, the operator may modify the values Cptval given by default by the automatic control method DPA because it has more or less detailed knowledge of the real context of the circular area AT of the first crane G1, and therefore be capable of associating for all or part of the angular sectors SA represented in the interference mapping C an adapted value Cptval.

This second alternative embodiment assumes that the operator validates his own setting so that the progress of the automatic control method DPA can continue. If it is optional in the scope of an interference mapping C provided as being able to evolve over time, it is essential in the scope of an interference mapping C provided as fixed/non-evolutionary and only filled in by the operator before effective implementation of the automatic control method DPA.

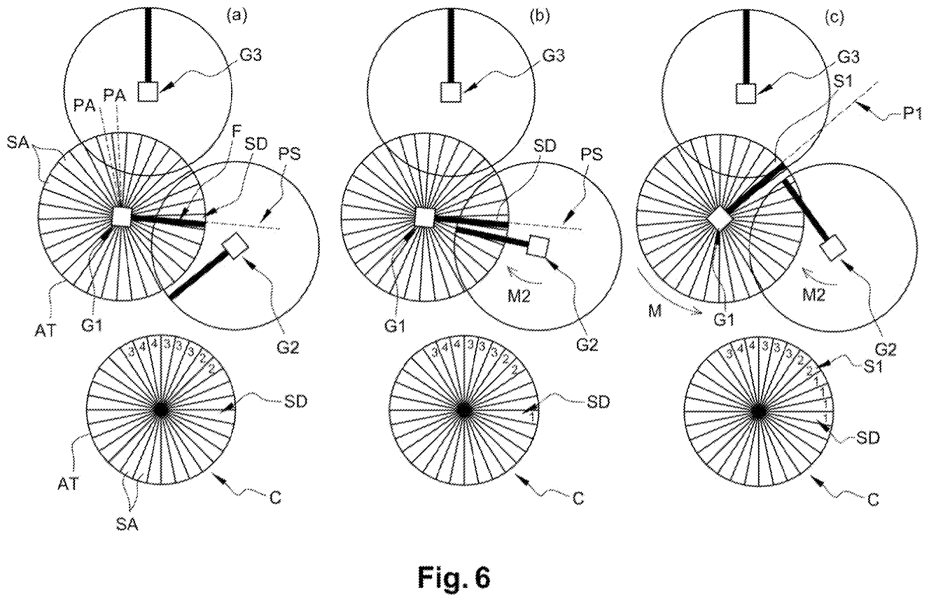

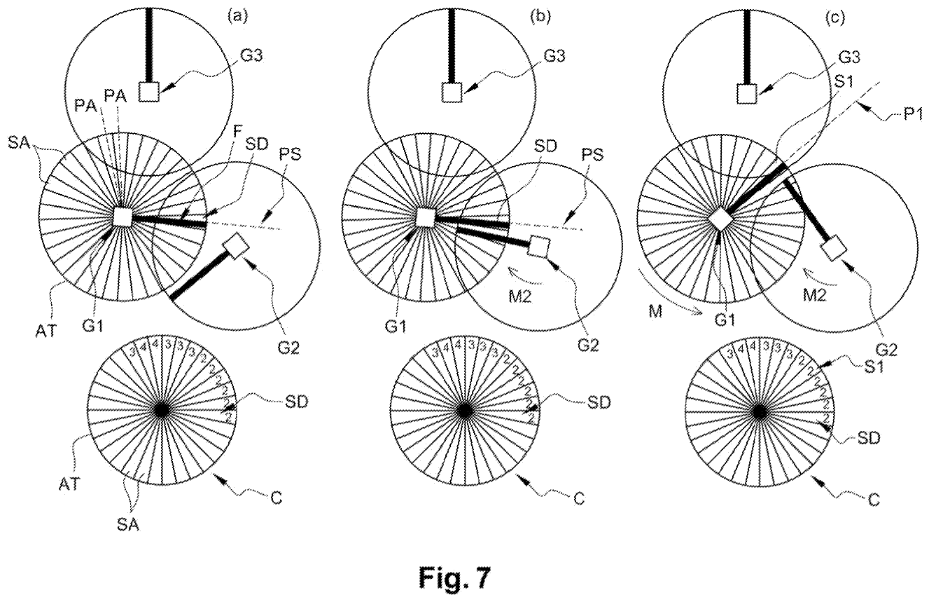

The embodiment implementing a real-time evolutionary (respectively non-evolutionary) mapping is illustrated in FIG. 6 (respectively FIG. 7), which takes up the site environment context presented in FIG. 4.

Thereafter, for questions of clarity and understanding of the operating principle of the automatic control method DPA when the interference mapping C is used:
In the schematic representation of the environmental context, the working circular area AT of the first crane G1 is represented as segmented, with its boom superimposed;
In the interference mappings C, when the value Cptval of the interference counter Cpt of an angular sector SA is equal to 0, the value Cptval is not represented in said angular sector SA.

Referring to FIG. 6a, the first crane G1 and the second crane G2 are both in two angular positions PA such that they are not interfering. The boom F of the first crane G1 is considered to be in a starting angular position PS included in an angular sector called the starting angular sector SD. The interference mapping C representative of the first crane G1 is such that the value Cptval of the interference counter Cpt of the starting angular sector SD is equal to 0.

The updating of the values Cptval of the interference counters Cpt of the angular sectors SA is implemented during a construction step EB taking place parallel to the first orientation sub-step EM1. The construction step EB starts following the detection of a risk of collision between the boom F of the first crane G1 and the boom F of the second crane G2 which moves according to an orientation movement M2, with an increment in the interference mapping C of the value Cptval of the interference counter Cpt of the starting angular sector SD (FIG. 6b).

Referring to FIG. 6c, following the situation of FIG. 6b, the second crane G2 continues its orientation movement M2 while the first crane G1 is oriented in the orientation direction M during the first orientation sub-step EM1 until reaching the first angular position P1 for which the risk of collision with the boom F of the second crane G2 is no longer detected. The angular sector SA containing the first angular position P1 is called the first angular sector S1. The construction step EB continues parallel to this orientation such that the value(s) Cptval of the interference counter(s) Cpt of the angular sector(s) SA crossed by the boom F of the first crane G1, and for which the risk of collision has continued to be detected, is/are incremented in the interference mapping C. This means that the value Cptval of the interference counter Cpt of the first angular sector S1, is not incremented.

The update of the interference mapping C is stored by the automatic control method DPA.

With reference to FIGS. 7a, 7b and 7c, insofar as no construction step EB is implemented in the control method, the interference mapping C representative of the working circular area AT of the crane G1 does not evolve whether or not there is detection of a risk of collision then implementation of the orientation sub-step EM1, the values Cptval of the interference counters Cpt of each of the angular sectors SA remaining those entered by the operator during the setting sub-step EP.

It should be noted that depending on the application situation, the boom F of the first crane G1 can be positioned in a first angular sector S1 which is included in a zone of interference with another crane, as long as the risk of collision is no longer detected.

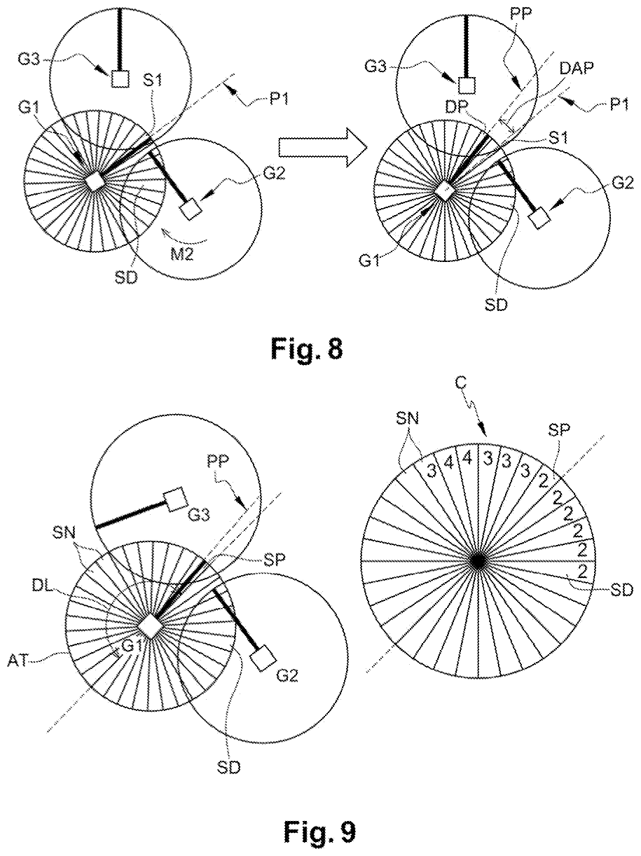

With reference to FIG. 8, which either follows FIG. 6 or FIG. 7, and according to the definition of the second orientation sub-step EM2, which as a reminder is optional, the boom F of the first crane G1 is moved from the first angular position P1, included in the first angular sector S1, to the precautionary angular position PP. The angular sector SA comprising the precautionary angular position PP is called the precautionary angular sector SP.

According to different embodiments of the invention, the precautionary angular distance DAP may either be fixed by the designers of the invention or be configurable, for example through a setting implemented by the operator during the initial setting step EP. It can for example be between 3 degrees and 10 degrees. In one embodiment, the precautionary angular distance DAP is between 3 and 5 degrees, and for example equal to 3 degrees.

According to the first angular position P1, the angular distance defining the first angular sector S1, and the value of the precautionary angular distance DAP, it remains possible that after displacement of the boom F over the precautionary angular distance DAP, the boom F is positioned on a precautionary angular position PP which is also included in the first angular sector S1. In this case, the first angular sector S1 becomes the precautionary angular sector SP. In the preferred embodiment, for which the angular distance of all the angular sectors is equal to 3 degrees and therefore to the precautionary angular distance DAP, the precautionary angular sector SP corresponds to the angular sector SA adjacent downstream to the first angular sector S1 in the orientation direction M of the boom F of the first crane G1.

With reference to FIGS. 9 to 12, and as indicated previously, the boom F of the first crane G1 may optionally still be oriented in the orientation direction M from the precautionary angular position PP (or the first angular position P1 if the second orientation sub-step EM2 is not implemented) until a final angular position PF. The angular sector SA comprising the final angular position is called final angular sector SF. The final angular sector SF then the final angular position are determined/identified during the selection sub-step ES.

With reference to FIG. 9, the final angular sector SF is selected from several angular sectors called the nearby angular sectors SN, which are included in a limit angular distance DL defined as being non-zero and less than or equal to 360° from the precautionary angular sector SP included. In the presented embodiment, the limit angular distance DL is equal to 180°. This means that, depending on the result from the selection sub-step ES, the final angular sector SF may correspond to the precautionary angular sector SP (or to the first angular sector S1 if the second orientation sub-step EM2 is not implemented in the automatic control method DPA), in which case the automatic control method DPA does not proceed to the third orientation sub-step EM3. Consequently, this means that the final angular position PF corresponds to the precautionary angular position PP (or the first angular position P1 if the second orientation sub-step EM2 is not implemented). The automatic control method DPA verifies whether this situation is encountered during a verification phase Q4, taking place between the selection sub-step ES and the third orientation step EM3. Subsequently, in order to explain the operating principle of the selection sub-step, it is considered that the second orientation sub-step EM2 is implemented.

During the selection sub-step ES, the automatic control method DPA compares the value Cptval of the interference counter Cpt of each of the nearby angular sectors SN with a minimum value val_min and a maximum value val_max, both integers and included in the value interval that Cptval can take. In the presented embodiment, the minimum value val_min and the maximum value val_max are included in the integer interval [0,5].

The value val_min corresponds to a threshold for which any nearby angular sector SN having a lower or equal value Cptval of interference counter is considered to be a secured nearby angular sector SNS, that is to say a nearby angular sector SN for which the risk of interference is IR low, even zero.

Conversely, the value val_max corresponds to a threshold for which any nearby angular sector SN having an equal or greater value Cptval of interference counter is considered to be a risky nearby angular sector SR, that is to say a nearby angular sector SN for which the risk of interference IR is high or very high.

According to different alternative embodiments, either the minimum value val_min and maximum value val_max as well as the limit angular distance DL are fixed by the designers, or they may be optionally defined by the operator during the initial setting step EP. By default, according to a first alternative embodiment of the invention, the minimum val_min and maximum val_max values may correspond respectively to the lowest and to the highest of the values Cptval that the interference counters Cpt may take.

In a second alternative embodiment, the minimum value val_min could correspond to a percentage of the difference between the highest and the lowest of the values Cptval of the interference counter Cpt, the minimum value val_min being rounded off to the nearest unit if the difference is not an integer value. For example, the minimum value val_min is respectively equal to 2 or 3 if the difference between the highest and the lowest value Cptval is equal to 2.4 or 2.8. Note that if the difference is equidistant from two units, the minimum value val_min would be equal to the largest of the units. For example, if the difference is equal to 2.5, then the minimum value val_min is equal to 3. The minimum value val_min and the maximum value val_max may also be modified/adapted automatically in the case that no secured nearby angular sector SNS is identified among the one or more nearby angular sectors SN (see below)

When no nearby angular sector SN is a risky nearby angular sector SR, the final angular sector SF is chosen such that it corresponds to the nearest first secured nearby angular sector SNS, in the orientation direction M of the boom F of the first crane G1, of the precautionary angular sector SP included. The final angular position PF is then identified as the angular position or the first position of the angular positions included in the final angular sector PF in the orientation direction M.

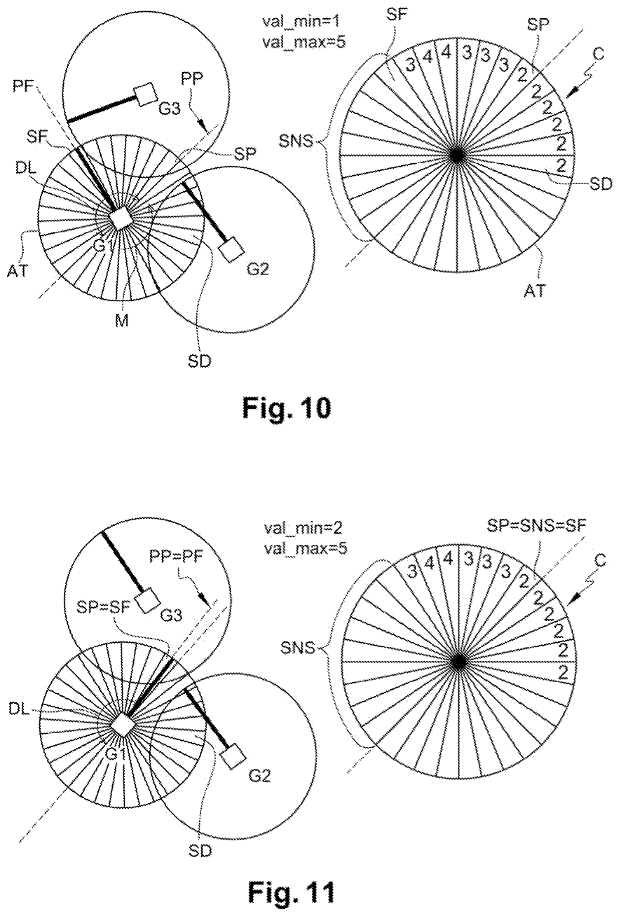

In the example illustrated in FIG. 10, which uses the application context given in FIG. 9, and for which the minimum value val_min and the maximum value val_max are considered to be equal to 1 and 5 respectively, the secured nearby angular sectors SNS correspond to the nearby angular sectors SN whose value Cptval of interference counter is less than or equal to 1, namely here those having a value Cptval of zero or equal to 1. The precautionary angular sector SP is not part of these secured nearby angular sectors SNS, because it has a value Cptval equal to 2.

Consequently, the automatic control method continues the orientation of the boom F of the first crane G1 according to the orientation direction M from the precautionary angular sector SP (or from the first angular sector S1) until reaching the angular position or the first position of the angular positions comprised in the final angular sector SF, which here corresponds to the first secured nearby angular sector SNS having zero value Cptval of interference counter Cpt in the orientation direction M; this angular position being the final angular position PF.

In the example illustrated in FIG. 11, for which the application context of FIG. 9 is repeated but this time for a minimum value val_min and a maximum value val_max equal to 2 and 5 respectively, the secured nearby angular sectors SNS correspond to the nearby angular sectors SN whose value Cptval of interference counter is less than or equal to 2, namely here the nearby angular sectors SN having a value Cptval zero or equal to 1 or equal to 2. In this application context, the automatic control method DPA does not implement the third orientation step EM3, having determined that the final angular sector SF corresponds to the precautionary angular sector SP, since it has a value Cptval equal to 2. Consequently, the final angular position PF is the precautionary angular position PP.

In the case that the limit angular distance DL does not contain any secured nearby angular sector SNS, the automatic control method DPA may increment the minimum value val_min until it identifies one or more secured nearby angular sectors SNS in the limit angular distance DL.

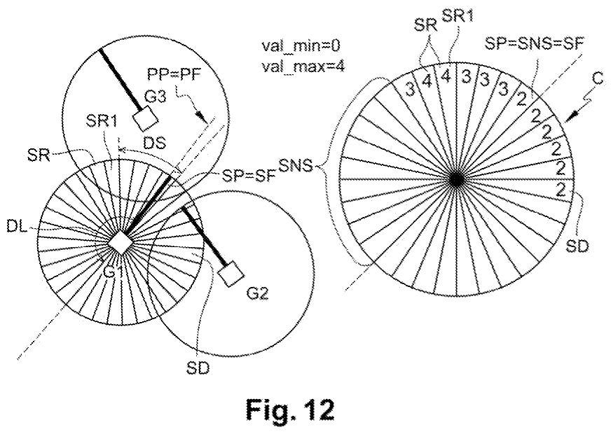

With reference to FIG. 12 for which the application context of FIG. 9 is repeated and for which the minimum value val_min and the maximum value val_max are respectively equal to 0 and 5, when the nearby angular sectors SN comprise one or more risky nearby angular sectors SR, the operating principle of the automatic control method DPA is defined such that the boom F of the first crane G1 must not cross, in the orientation direction M, the risky nearby angular sector SR or the first sector of the risky nearby angular sectors SR1 encountered, even if secured nearby angular sectors SNS are situated downstream of the risky nearby angular sector SR or of the first sector of the risky nearby angular sectors SR1.

According to the same principle as previously, the automatic control method DPA then seeks to determine a final angular sector SF among secured nearby angular sectors SNS no longer included in the limit angular distance DL, but in a new angular interval, called the secured angular interval DS, including the precautionary angular sector SP (or the first angular sector S1) and excluding the risky nearby angular sector SR or the first sector of the risky nearby angular sectors SR1.

In the case that the secured angular interval DS does not contain any secured nearby angular sector SNS, the automatic control method DPA increments the minimum value val_min until one or more secured nearby angular sectors SNS are identified in the secured angular interval DS. This situation is presented in FIG. 11, for which there is no secured nearby angular sector SNS in the secured angular interval DS such as having a value Cptval of interference counter Cpt of zero. Following two successive increments, the automatic control method DPA succeeds in identifying a single secured nearby angular sector SNS having a value Cptval of the interference counter Cpt equal to 2, and which corresponds to the precautionary angular sector SP in the illustrated example. The automatic control method DPA then considers that the precautionary angular sector SP (respectively the precautionary angular position SP) corresponds to the final angular sector SF (respectively the final angular position PF).

During the orientation sub-steps EM1, EM2, EM3, the automatic control method DPA verifies during reception phases Q2 (before the second orientation sub-step EM2), Q3 (before the selection sub-step ES) and Q5 (before the third orientation sub-step EM3) if it has received information representative of a detection of a risk of collision. If so, the automatic control method DPA resumes from the beginning and repeats the boom automatic and autonomous orientation step EM.

1-21. (canceled)

22. An automatic control method for the automatic control of a crane in an automated control state, the crane comprising a boom and at least one collision avoidance system adapted to detect a risk of collision on a right side and a left side of the boom, the boom being controllable in orientation about an orientation axis and operating in a working circular area, the automatic control method comprising, when the at least one collision avoidance system detects a risk of collision with an obstacle located on the right side or the left side of the boom when the boom is in a starting angular position:
a boom automatic and autonomous orientation step during which the boom is oriented from the starting angular position in an orientation direction, which is opposite to the right or left side for which the risk of collision is detected, at least until the at least one collision avoidance system no longer detects the risk of collision.

23. The automatic control method according to claim 22, wherein during the boom automatic and autonomous orientation step, the boom is oriented in the orientation direction until reaching or exceeding a first angular position corresponding to an angular position, starting from the starting angular position, from which the at least one collision avoidance system no longer detects risk of collision.

24. The automatic control method according to claim 23, wherein during the boom automatic and autonomous orientation step, the boom is oriented in the orientation direction until reaching or exceeding a precautionary angular position located at a precautionary angular distance from the first angular position.

25. The automatic control method according to claim 24, wherein the precautionary angular distance is non-zero and configurable.

26. The automatic control method according to claim 23, wherein the boom automatic and autonomous orientation step includes a selection sub-step, wherein during the selection sub-step, a final angular position for which an interference parameter representative of a level of risk of interference between the boom and an obstacle is low is selected, and the boom is oriented in the orientation direction until reaching and stopping in the final angular position.

27. The automatic control method according to claim 26, wherein the automatic control method uses an interference mapping representative of the working circular area and for the circular working area, each angular position is associated with a value of the interference parameter, and, during the selection sub-step, the final angular position is selected from the angular positions of the interference mapping according to the associated values of the interference parameter for the angular positions.

28. The automatic control method according to claim 27, for which, in the interference mapping, the values of interference parameter associated with each of the angular positions of the interference mapping are either fixed or evolve over time.

29. The automatic control method according to claim 28, for which the interference mapping is constructed by implementing the following steps:
an initial segmentation step during which the working circular area is segmented into several angular sectors, each of the angular sectors comprising one or more angular positions;
an initial setting step during which each of the several angular sectors is associated with an interference counter representative of a level of risk of interference in an angular sector of the several angular sectors, the angular sector associated between the boom and a possible obstacle, wherein the values of the interference parameter associated with the angular positions within the angular sector correspond to the interference counter associated with the angular sector; and
when the values of interference parameter have been predicted to evolve over time, a construction step, whether the boom is moving or not, and each time the boom is present in an angular position of an angular sector among the several angular sectors, and that the at least one collision avoidance system detects a risk of collision in the angular sector, wherein during the construction step, the value of the interference counter in the angular sector, and consequently the value of the interference parameter of the one or more angular positions within the angular sector, is incremented.

30. The automatic control method according to claim 29,
wherein during the boom automatic and autonomous orientation step, the boom is oriented in the orientation direction until reaching or exceeding a precautionary angular position located at a precautionary angular distance from the first angular position, and
wherein during the selection sub-step, the angular sector containing the final angular position, called the final angular sector, is selected from angular sectors, called the nearby angular sectors, which include: the angular sector containing the precautionary angular position, called the precautionary angular sector, and angular sectors which are distributed over a given limit angular distance from the precautionary angular sector.

31. The automatic control method according to claim 30, wherein the limit angular distance is less than or equal to 180 degrees.

32. The automatic control method according to claim 30, wherein during the selection sub-step, the values of the interference counters of the nearby angular sectors are compared with a minimum value and the nearby angular sector(s) having a value of interference counter less than or equal to the minimum value is or are called the secured nearby angular sectors, and the final angular sector is selected from the secured nearby angular sector(s).

33. The automatic control method according to claim 32, wherein during the selection sub-step, the minimum value corresponds to the lowest value of the interference counters of the nearby angular sectors, or to the lowest value of the interference counters of the nearby angular sectors incremented by a configurable increment value.

34. The automatic control method according to claim 33, wherein during the selection sub-step, the final angular sector is selected as being a secured nearby angular sector, among the secured nearby angular sectors, and which is: either the one that is angularly nearest the precautionary angular sector; either the one which, on the one hand, has a value of the interference counter which is equivalent to the lowest value of the interference counters of the nearby angular sectors and, on the other hand, is the angularly nearest the precautionary angular sector.

35. The automatic control method according to claim 32, wherein during the selection sub-step, the values of the interference counters of the nearby angular sectors are compared with a maximum value and the nearby angular sector(s) having a value of interference counter greater than or equal to the maximum value is called the risky nearby angular sector(s), and wherein the final angular sector is selected from the nearby angular sectors extending in a secured angular interval delimited, on the one hand, by the precautionary angular sector included and, on the other hand, by the risky nearby angular sector or by the first sector of the risky nearby angular sectors starting from the precautionary angular sector excluded, so that, during the boom automatic orientation step, the boom does not reach and does not exceed risky nearby angular sector or the first sector of the risky nearby angular sectors starting from the precautionary angular sector.

36. The automatic control method according to claim 35, wherein during the selection sub-step, the final angular sector is selected as the nearby angular sector having the lowest value of the interference counter in the secured angular interval, independently of the values of the interference counters of the nearby angular sectors located beyond the secured angular interval.

37. The automatic control method according to claim 30, wherein during the selection sub-step, the final angular position corresponds, in the final angular sector, to the angular position that is spatially nearest the precautionary angular position included.

38. The automatic control method according to claim 29, in which during the initial segmentation step, the working circular area is segmented into at least 36 angular sectors.

39. The automatic control method according to claim 38, wherein during the initial segmentation step, the working circular area is segmented into at least 120 isometric angular sectors.

40. The automatic control method according to claim 29, wherein during the initial setting step, the value of the interference counter of each of the several angular sectors is the smallest value defined in the automatic control method.

41. An automatic control system for automatic control of a crane in an automated control state, the crane comprising a boom and at least one collision avoidance system adapted to detect a risk of collision on a right side and a left side of the boom, the boom being controllable in orientation about an orientation axis and operating in a working circular area, the automatic control system communicating/exchanging information with the at least one collision avoidance system and controlling the boom, and in which the automatic control system is designed to contain and to execute, when the at least one collision avoidance system detects a risk of collision with an obstacle located on the right side or the left side of the boom when the boom is in an angular position, a program comprising a list of instructions to implement the automatic control method according to claim 22.

42. An automatically controllable crane comprising a boom and at least one collision avoidance system adapted to detect a risk of collision on a right side and a left side of the boom, the boom being controllable in orientation about an orientation axis and operating in a working circular area, the automatically controllable crane further comprising the automatic control system according to claim 41, wherein the automatic control system is connected to the at least one collision avoidance system and is configured to communicate/exchange information with the at least one collision avoidance system and with the boom to control the boom in rotation in the automated control state.
